(19) United States
(12) Patent Application Publication
(10) Pub. No.: US 2004/0247933 A1
(43) Pub. Date: Dec. 9, 2004

(54) Bipolar asymmetric carbazole-based host materials for electrophosphorescent guest-host OLED systems

(75) Inventor: Travis P. S. Thoms, San Lorenzo, CA (US)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, OHTA-KU (JP)

(21) Appl. No.: 10/452,732

(22) Filed: Jun. 3, 2003

(51) Int. Cl. H05B 33/12

(52) U.S. Cl. 428/690; 428/917; 313/504; 313/506

(57) ABSTRACT

An organic light-emitting device (OLED) in which a bipolar carbazole-based material expressed according to the following general formula:

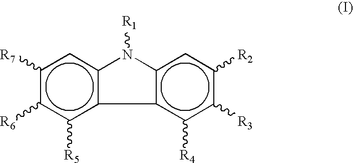

is used as a host material in a guest-host layer, such as the emissive layer and/or one of the charge transport layers. In the general formula above, R₁ represents an electron donating moiety or an electron accepting moiety; each R₂ to R₇ is present optionally; and each R₂ to R₇ independently represents an electron donating moiety or an electron accepting moiety.

### BACKGROUND OF THE INVENTION

1. Field of the Invention

The present invention relates to an organic light emitting device (OLED) in which a bipolar carbazole is used as the host material in a guest-host system.

2. Description of the Related Art

Significant efforts have been expended in developing suitable materials for use in organic light emitting devices (OLEDs). Such devices are commercially attractive because they offer the promise of low-cost fabrication of high-density pixeled displays exhibiting bright electroluminescence with long life times, high efficiency and wide color range.

A typical OLED is fabricated by sandwiching an emissive layer between an anode and a cathode. Improved performance can be obtained by the provision of additional layers around the emissive layers so as to improve charge transport capabilities, such as an electron transport layer and/or a hole transport layer, or an electron blocking and/or hole blocking layer.

In addition, it is possible to form these layers from a host material doped with another material (the guest) designed to achieve the desired effect of the layer (for example, to achieve a hole transport effect, an electron transport effect, or an emissive effect). Such a guest-host system for phosphor-based OLEDs shows greatly improved efficiencies over traditional neat phosphor films due to the reduction of aggregation and triplet-triplet state annhilation.

Accordingly, in a guest-host system, the selection of an appropriate host is difficult, especially since the non-emissive triplet excited state of the host material must ordinarily be higher than the emissive triplet excited state of the guest phosphor. Finding such a host material becomes more difficult as the emission wavelength for the guest becomes shorter because as the wavelength shortens, the emissive triplet excited state becomes higher.

It is also difficult to select a host material which meets the above criteria and allows for efficient charge transport through the device. Current host materials tend to enhance and allow for hole transport. However, at the same time, they provide comparatively little electron transport and electron injection into the emissive layer.

Moreover, even if able to provide both hole and electron transport, current host materials, such as 4,4′ biscarbazole biphenyl (CBP), tend to crystallize, making them difficult to use in OLEDs.

Because of consumer expectations of good efficiency, long lifetime and pure color for OLEDs, a need exists for development of improved host materials used for guest-host systems in OLEDs.

### SUMMARY OF THE INVENTION

It is an object of the invention to provide an improved OLED in which a bipolar carbazole or its derivatives are used as the host material in a guest-host system.

Thus, in one aspect, the invention is an OLED in which an emissive layer is sandwiched at least between a cathode and an anode and in which the emissive layer is a guest-host layer and includes a bipolar carbazole or a derivative thereof as a host material. Suitable bipolar carbazoles and their derivatives are expressed according to the following general formula (I):

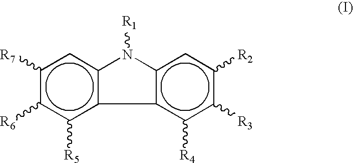

wherein R₁ represents an electron donating moiety or an electron accepting moiety, wherein each R₂ to R₇ is present optionally, and wherein each R₂ to R₇ independently represents an electron donating moiety or an electron accepting moiety.

Preferably, if R₁ represents an electron donating moiety, R₁ is an alkyl group, a phenyl group, or a heterocyclic compound. Further, if R₁ is a phenyl group, R₁ is preferably a xylene or benzene; or if R₁ is a heterocyclic compound, R₁ is preferably an indole. Alternatively, if R₁ represents an electron accepting moiety, R₁ preferably is a cyanobenzene, benzylnapthaline or pyridine.

Preferably, each R₂ to R₇ also has hole transport properties. In addition, if R₂, R₃, R₄, R₅, R₆ or R₇ represents an electron donating moiety, then that R₂, R₃, R₄, R₅, R₆ or R₇ is a phenyl amine or carbazole. Alternatively, if R₂, R₃, R₄, R₅, R₆ or R₇ represents an electron accepting moiety, then that R₂, R₃, R₄, R₅, R₆ or R₇ preferably is a quinoline or quinaldine.

Due to the large band-gap and high energy states of bipolar carbazoles, the use of a bipolar carbazole or its derivatives as a host allows green, red and even blue electroluminescent emission from guest phosphors. Suitable guest phosphors include Ir(ppy)₃ (i.e., tris[2-(2-pyridinyl)phenyl-C,N]-iridium), and Ir-28, which is an iridium complex oriented to a phenyl isoquinoline ligand.

In addition, a bipolar carbazole or its derivatives allow for the combination of both electron donating and electron accepting moieties. Accordingly, with the combination of both electron donating and electron accepting moieties on the host molecular structure, the use of such a bipolar carbazole or its derivatives results in both improved hole and electron injection throughout the emissive layer.

Additionally, a bipolar carbazole or its derivatives according to formula (I) is less inclined to crystallize, offering a more suitable morphology than currently known hosts that provide both hole and electron transport, such as the afore-mentioned 4,4′ biscarbazole biphenyl (CBP).

In a further aspect, the invention is an OLED having an emissive layer sandwiched between at least one charge transport layer and an anode and a cathode. The charge transport layer can be either an electron transport layer or a hole transport layer, or both may be included. According to this aspect of the invention, the charge transport layer is a guest-host layer and includes a carbazole-based material or derivative according to the above general formula (I) wherein R₁ and R₂ to R₇ are specified above.

This brief summary has been provided so that the nature of the invention may be understood more quickly. A more complete understanding of the invention can be obtained by reference to the following detailed description of the preferred embodiment thereof in connection with the attached drawings.

### DETAILED DESCRIPTION OF THE DRAWINGS

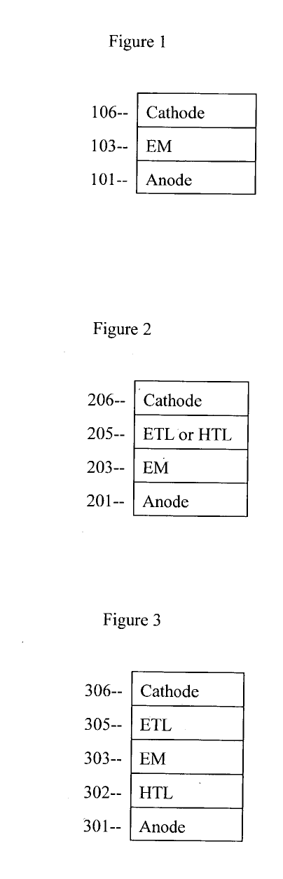

FIG. 1 is a schematic cross-sectional view of a single layer organic light emitting device.

FIG. 2 is a schematic cross-sectional view of a two layer organic light emitting device.

FIG. 3 is a schematic cross-sectional view of a three layer organic light emitting device.

### DETAILED DESCRIPTION OF INVENTION

The bipolar carbazole and its derivatives used in the present invention have the following general structure:

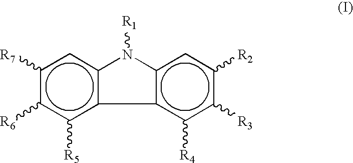

In the above formula (I), R₁ represents an electron donating moiety or an electron accepting moiety; each R₂ to R₇ is present optionally; and each R₂ to R₇ independently represents an electron donating moiety or an electron accepting moiety.

Preferably, if R₁ represents an electron donating moiety, R₁ is an alkyl group, a phenyl group, or a heterocyclic compound. Further, if R₁ is a phenyl group, R₁ is preferably a xylene or benzene; or if R₁ is a heterocyclic compound, R₁ is preferably an indole. Alternatively, if R₁ represents an electron accepting moiety, R₁ preferably is a cyanobenzene, benzylnapthaline or pyridine.

Preferably, each R₂ to R₇ also has hole transport properties. In addition, if R₂, R₃, R₄, R₅, R₆ or R₇ represents an electron donating moiety, then that R₂, R₃, R₄, R₅, R₆ or R₇ is a phenyl amine or carbazole. Alternatively, if R₂, R₃, R₄, R₅, R₆ or R₇ represents an electron accepting moiety, then that R₂, R₃, R₄, R₅, R₆ or R₇ preferably is a quinoline or quinaldine.

An advantage of the disclosed bipolar carbazole materials for use in OLEDs according to the invention is that these compounds exhibit a large band-gap and high energy state. Therefore, as a host, a bipolar carbazole or its derivative allows a wide range of green, red and even blue electroluminescent emission from guest phosphors.

A second advantage is that due to their bipolar nature, bipolar carbazoles allow for the combination of both electron donating and electron accepting moieties. Accordingly, the use of bipolar carbazole materials may result in improved hole and/or electron injection throughout the emissive layer.

A further advantage is that a bipolar carbazole or a derivative thereof according to formula (I) is less inclined to crystallize, offering a more suitable morphology than currently known hosts that provide both hole and electron transport, such as 4,4′ biscarbazole biphenyl (CBP).

Some preferred bipolar carbazoles or its derivatives represented by formula (I) include the following compounds:

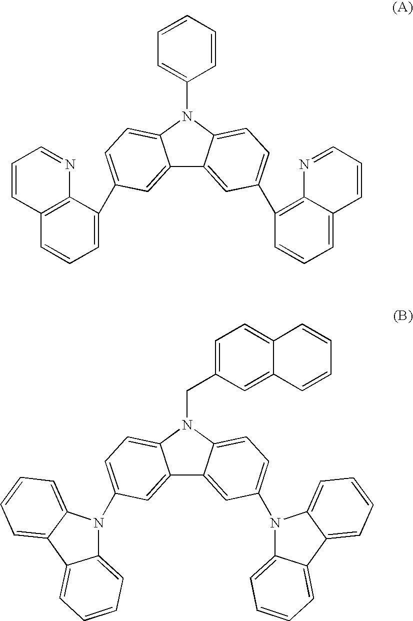

Bipolar carbazoles suitable for use with the invention or as starting materials for preparing derivatives according to the invention, such as the foregoing compounds (A) and (B) can be made using methods known in the art.

The synthesis of the above representative compound (A) is as follows:

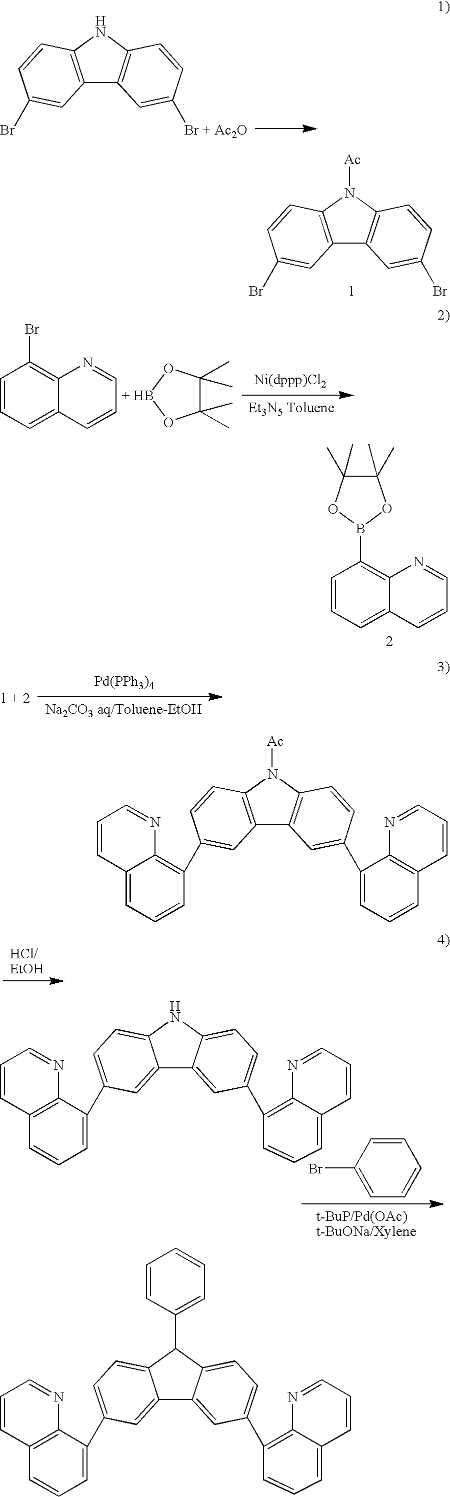

The synthesis of the above representative compound (B) is as follows:

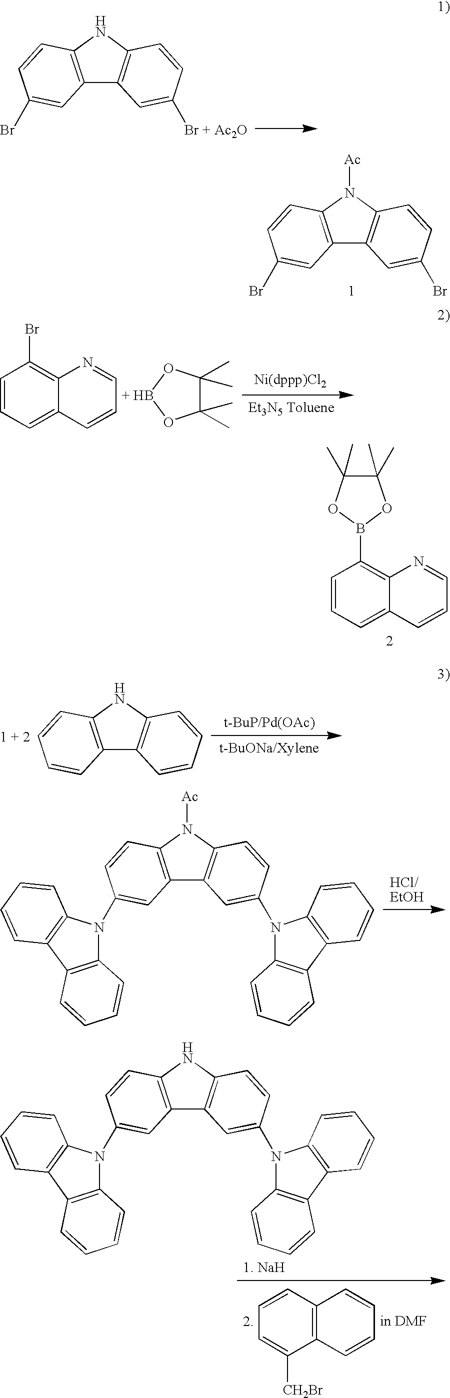

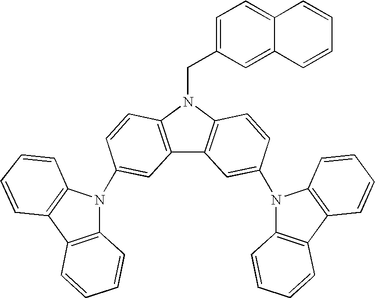

The compound expressed according to formula (I) can be used as a host in a guest-host system. In a guest-host system of the present invention, suitable guest phosphors include Ir(ppy)₃, tris[2-(2-pyridinyl)phenyl-C,N]-iridium, and Ir-28, an iridium complex oriented to a phenyl isoquinoline ligand, which are depicted below.

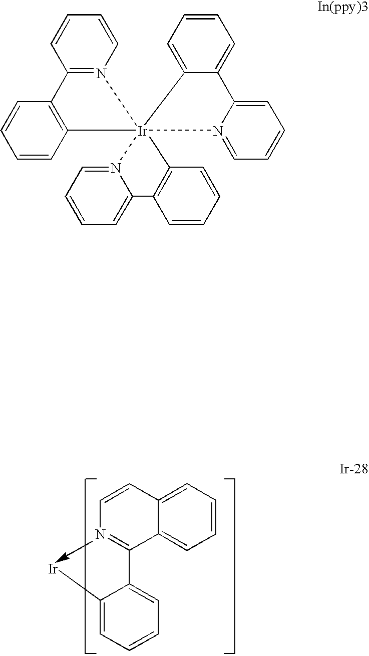

As shown in FIG. 1, in one typical guest-host system, the present invention is a single-layer OLED in which an emissive layer 103 is sandwiched between a cathode 106 and an anode 101. In such an OLED, the emissive layer is a guest-host layer and includes a bipolar carbazole of the present invention or its derivatives as a host material.

The present invention may also be a multi-layer OLED having an emissive layer sandwiched between at least one charge transport layer and an anode and a cathode.

As demonstrated in FIG. 2, one such multi-layer device, a two-layer OLED, consists of an emissive layer 203 sandwiched between at least one charge transport layer 205 and an anode 201 and a cathode 206. The charge transport layer 205 can either be an electron transport layer or a hole transport layer.

Alternatively, as shown in FIG. 3, both an electron transport layer 305 and hole transport layer 302 may be present. In this multi-layer device, a three-layer OLED, the emissive layer 303 is sandwiched between both transport layers. Additionally, the electron transport layer 305, emissive layer 303, and hole transport layer 302 are sandwiched between an anode 301 and a cathode 306.

In multi-layer OLEDs, whether two-layer or three-layer, either the emissive layer or any charge transport layer may be a guest-host layer and includes a bipolar carbazole of the present invention or its derivatives as a host material.

General procedures for a fabrication of an OLED are as follows: To construct a three layer device, as in FIG. 3, a clean substrate coated with a patterned layer of indium tin oxide (ITO) is first obtained. Next, the substrate is treated with O₂ plasma for 1-5 minutes. Afterwards, the substrate is placed in a thermal evaporator and the pressure is lowered. Then, organic and metallic layers are evaporated onto the substrate at a rate approximately between 1-3 Å/s. These organic and metallic layers may vary depending upon the desired OLED. A hole transport layer is usually evaporated with a thickness of ˜200 Å. Next, an emissive layer is evaporated with a host and dopant. Normally, 100-400 Å of the emissive layer is deposited. Then, an electron transport material is evaporated to form a layer that is usually 200-400 Å thick. After the evaporation of the preferred organic and metallic layers, a mask is placed adjacent to the layer to define where metal areas corresponding to cathodes are to be evaporated. Then, about 120 Å of a Li—Al alloy is evaporated to improve electron injection into the device. Finally, after about 1500 Å of Al is deposited, the evaporator is allowed to cool.

Fabrication of a suitable emissive and/or charge transport layer using a bipolar carbazole or its derivatives according to the above formula (I) can be accomplished through use of thermal deposition in a vacuum, or by spin coating of a solution thereof. In addition, high-density pixeled displays can be fabricated through use of suitable masking procedures, or by use of thermal or piezoelectric ink jet printing techniques.

Example 1 shows the structure and fabrication of a representative OLED of the present invention.

### EXAMPLE 1

An OLED device was fabricated over a substrate of indium tin oxide (ITO) on which the following layers were formed in the order listed: a 30 nm layer of Canon FL 03 (described below), a 20 nm layer of 7% Ir-28:2-TT-89 (described below), a 50 nm layer of bisphenylphenanthroline, and a bilayer cathode comprised of a 12 nm layer of a Li—Al alloy and a 150 nm layer of Al. Canon FL03 (i.e., DFLDPBi, as reported in Polymer Prepr., Japan, vol. 47, pp. 1862 (1998)) refers to a hole transport material. Ir-28:2-TT-89 refers to an Iridium guest emitter and 3,6-di(8-quinolyl)-N-phenyl-carbazole (a bipolar carbazole host of formula (I) above). Bisphenylphenanthroline (BPhen) refers to an electron transport material. The device was fabricated according to procedures known in the art. The device emitted red light with a brightness of 310 cd/m² at 4.5 lm/W.

It is to be understood that the invention is not limited to the above-described embodiments and that various changes and modifications may be made by those of ordinary skill in the art without departing from the spirit and scope of the invention.

What is claimed is:

1. An organic light-emitting device comprising an anode, a cathode, and one or more organic compound layers sandwiched between the anode and cathode, wherein the emissive layer comprises a guest-host layer and includes a carbazole-based host expressed according to the following general formula (I): 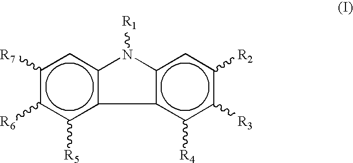
wherein R₁ are presents an electron donating moiety or an electron accepting moiety,
wherein each R₂ to R₇ is present optionally, and
wherein each R₂ to R₇ independently represents an electron donating moiety or an electron accepting moiety.

2. An organic light-emitting device according to claim 1, wherein the carbazole-based material is an emissive host.

3. An organic light-emitting device according to claim 1, wherein the electron donating moiety of R₁ is an alkyl, phenyl, or heterocyclic compound.

4. An organic light-emitting device according to claim 3, wherein said phenyl is a xylene or benzene.

5. An organic light-emitting device according to claim 3, wherein said heterocyclic compound is an indole.

6. An organic light-emitting device according to claim 1, wherein the electron accepting moiety of R₁ is a cyanobenzene, benzylnapthaline, or pyridine.

7. An organic light-emitting device according to claim 1, wherein the electron donating moiety of R₂, R₃, R₄, R₅, R₆ or R₇ has hole transport properties.

8. An organic light-emitting device according to claim 1, wherein the electron donating moiety of R₂, R₃, R₄, R₅, R₆ or R₇ is a phenyl amine or carbazole.

9. An organic light-emitting device according to claim 1, wherein the electron accepting moiety of R₂, R₃, R₄, R₅, R₆ or R₇ is quinoline or quinaldine.

10. An organic light-emitting device according to claim 1, wherein the carbazole-based material is bipolar, capable of promoting both hole and electron transport through the host layer.

11. An organic light emitting device comprising an emissive layer sandwiched between at least one charge transport layer and an anode and a cathode,
wherein the charge transport layer is either an electron transport layer or a hole transport layer, and
wherein the charge transport layer comprises a guest-host layer and includes a carbazole-based host according to the following general formula (I): 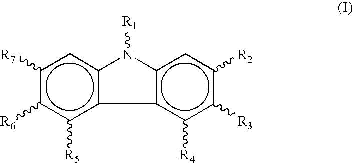
wherein R₁ represents an electron donating moiety or an electron accepting moiety,
wherein each R₂ to R₇ is present optionally, and
wherein each R₂ to R₇ independently represents an electron donating moiety or an electron accepting moiety.

12. An organic light-emitting device according to claim 11, wherein the electron donating moiety of R₁ is an alkyl, phenyl, or heterocyclic compound.

13. An organic light-emitting device according to claim 12, wherein said phenyl is a xylene or benzene.

14. An organic light-emitting device according to claim 12, wherein said heterocyclic compound is an indole.

15. An organic light-emitting device according to claim 11, wherein the electron accepting moiety of R₁ is a cyanobenzene, benzylnapthaline, or pyridine.

16. An organic light-emitting device according to claim 11, wherein the electron donating moiety of R₂, R₃, R₄, R₅, R₆ or R₇ has hole transport properties.

17. An organic light-emitting device according to claim 11, wherein the electron donating moiety of R₂, R₃, R₄, R₅, R₆ or R₇ is a phenyl amine or carbazole.

18. An organic light-emitting device according to claim 11, wherein the electron accepting moiety of R₂, R₃, R₄, R₅, R₆ or R₇ is quinoline or quinaldine.

19. An organic light-emitting device according to claim 11, wherein the carbazole-based material is bipolar, capable of promoting both hole and electron transport through the host layer.

20. An organic light-emitting device according to claim 11, wherein the charge transport layer is an electron transport layer.

21. An organic light-emitting device according to claim 11, wherein the charge transport layer is a hole transport layer.
